(19) United States
(12) Patent Application Publication
(10) Pub. No.: US 2015/0008629 A1
(43) Pub. Date: Jan. 8, 2015

(54) SPIRAL SPRING

(71) Applicant: CHO HATSUJO KABUSHIKI KAISHA, Nagoya-shi, Aichi (JP)

(72) Inventors: Madoka Kuno, Nagoya-shi (JP); Takashi Gotoh, Nagoya-shi (JP); Shoji Ichikawa, Nagoya-shi (JP); Kazuyoshi Nono, Nagoya-shi (JP); Toshinori Imai, Nagoya-shi (JP)

(73) Assignee: CHO HATSUJO KABUSHIKI KAISHA, Nagoya-shi, Aichi (JP)

(21) Appl. No.: 14/368,650

(22) PCT Filed: Nov. 7, 2012
(86) PCT No.: PCT/JP2012/078846

§ 371 Date: Jun. 25, 2014

(30) Foreign Application Priority Data
Jan. 25, 2012 (JP) 2012-13372

(51) Int. Cl. F16F 1/10

(52) U.S. Cl. CPC F16F 1/10
USPC 267/156

(57) ABSTRACT

A spiral spring for reducing maximum stress value and variations in stress distribution. The spiral spring is elastically deformable from a minimally to maximally deformed state. In maximally deformed state, the spiral spring includes a non-contact section, wherein at least some spring material portions are adjacent in radial direction not contacting each other, and a contact section, wherein all spring material portions are adjacent in radial direction contacting each other. An inner reference portion is corresponding to a central angle of 80° or more and 160° or less about a spiral center along a direction of spiral portion extension with a reference line connecting the spiral center and outer contact portion, wherein the outer end portion and outer fixing member contact in maximally deformed state, the inner reference portion being on a radially spiral portion inner side. The contact section is on a radially inner reference portion outer side.

### TECHNICAL FIELD

The present invention relates to a spiral spring for use in a seat back of a vehicle seat, a tumbling mechanism, a seat belt winding mechanism, and so forth, for example.

### BACKGROUND ART

As described in Patent Documents 1 and 2, a spiral spring is used in a vehicle seat. That is, the vehicle seat includes a seat back. The seat back is swingable in the front-rear direction. The spiral spring applies a biasing force in the forwardly inclining direction to the seat back in a rearwardly inclined state.

As the seat back is tilted rearward, the spiral spring is elastically deformed. Therefore, a stress is generated in the spiral spring. For example, in a maximally deformed state in which the amount of deformation in the winding direction with respect to the natural state (no-load state) is maximum, a compressive stress is generated on the radially inner side of a spring material, and a tensile stress is generated on the radially outer side of the spring material. The strength of the spiral spring is set such that the maximum value of the stress to be generated can be endured.

### RELATED-ART DOCUMENTS

### Patent Documents

Patent Document 1: Japanese Patent Application Publication No. 2010-274737 (JP 2010-274737 A)
Patent Document 2: Japanese Patent Application Publication No. 2009-61080 (JP 2009-61080 A)

### SUMMARY OF THE INVENTION

### Problem to be Solved by the Invention

However, the stress of the spiral spring differs among portions of the spiral spring. Therefore, the stress distribution is non-uniform over the spiral spring. For example, for a spiral spring of a non-contact type (a spiral spring in which portions of a spring material that are adjacent in the radial direction do not contact each other in the maximally deformed state) with a free outer end (with an outer end portion of the spiral spring retained on an outer fixing member in a swingable (moment-free) manner), the stress tends to be large at turn positions of 0.5 turns, 1.5 turns, 2.5 turns, and so forth from the inner end portion. On the other hand, the stress tends to be small at turn positions of one turn, two turns, three turns, and so forth from the inner end portion. Therefore, in designing the spiral spring, it is necessary to set the strength of the spiral spring such that the maximum value of the stress can be endured. If the maximum value of the stress is small, or if variations in stress distribution are small, the set value of the strength of the spiral spring can be accordingly reduced.

The spiral spring according to the present invention has been completed in view of the above problem. It is an object of the present invention to provide a spiral spring capable of reducing the maximum value of a stress and capable of reducing variations in stress distribution.

### Means for Solving the Problem

(1) In order to solve the above problem, the present invention provides a spiral spring made of a belt-like spring material and including an inner end portion that is fixed to an inner fixing member, an outer end portion that is swingably retained on an outer fixing member, and a spiral portion that extends spirally to couple the inner end portion and the outer end portion to each other, the spiral spring being elastically deformable from a minimally deformed state to a maximally deformed state by rotating the inner end portion and the outer end portion relative to each other, the spiral spring being characterized in that: in the maximally deformed state, the spiral spring includes a non-contact section, in which at least some portions of the spring material that are adjacent in a radial direction do not contact each other, and a contact section, in which all portions of the spring material that are adjacent in the radial direction contact each other; an inner reference portion is disposed in a section corresponding to a central angle of 80° or more and 160° or less about a spiral center of the spiral portion along a direction of extension of the spiral portion with reference to a reference line that connects between the spiral center and an outer contact portion, at which the outer end portion and the outer fixing member contact each other, in the maximally deformed state, the inner reference portion being disposed on a radially inner side of the spiral portion; and the contact section is disposed on a radially outer side of the inner reference portion.

Here, the term “belt-like” includes “wire-like”. That is, the width of the spring material in the lateral direction is not specifically limited. In addition, a position in the circumferential direction, in the maximally deformed state, with an end portion of the spiral portion on the inner end portion side defined as 0 is defined as the “turn position”. The term “spiral center of the spiral portion” refers to the center of an approximate circle in a section of the spiral portion corresponding to a turn position of 0 or more and 0.25 or less.

The spiral spring according to the present invention is a spiral spring with a free outer end. The spiral spring is elastically deformable from the minimally deformed state (a state in which the amount of deformation with respect to the natural state is minimum) to the maximally deformed state (a state in which the amount of deformation with respect to the natural state is maximum).

In the maximally deformed state, the spiral spring includes the non-contact section, in which at least some portions of the spring material that are adjacent in the radial direction do not contact each other, and the contact section, in which all portions of the spring material that are adjacent in the radial direction contact each other. That is, in the maximally deformed state, at least one non-contact section and at least one contact section are disposed in the circumferential direction of the spiral spring. Put the other way around, in the maximally deformed state, the entire circumference of the spiral spring is not occupied by only non-contact sections. In addition, in the maximally deformed state, the entire circumference of the spiral spring is not occupied by only contact sections.

The contact section is disposed on the radially outer side of the inner reference portion. The inner reference portion is disposed in a section corresponding to a central angle of 80° or more and 160° or less about a spiral center of the spiral portion along a direction of extension of the spiral portion with reference to a reference line that connects between the spiral center and an outer contact portion, at which the outer end portion and the outer fixing member contact each other, in the maximally deformed state. Moreover, the inner reference portion is disposed on the radially inner side of the spiral portion. Here, the position of the inner reference portion is set to a section corresponding to a central angle of 80° or more and 160° or less because no stress reduction effect is obtained in the case where the central angle is less than 80° or more than 160°.

In the maximally deformed state, the spiral spring according to the present invention includes the contact section and the non-contact section. In the contact section, all portions of the spring material that are adjacent in the radial direction contact each other. In the non-contact section, in contrast, at least some portions of the spring material that are adjacent in the radial direction do not contact each other. Therefore, a friction resistance in the circumferential direction is larger in the contact section than in the non-contact section.

With the spiral spring according to the present invention, a stress is controlled by intentionally setting the contact section to a desired position. That is, the contact section is intentionally created by setting the inner reference portion. Moreover, the position of the contact section is adjusted by setting the position of the inner contact portion to a section corresponding to a central angle of 80° or more and 160° or less. By adjusting the position of the contact section, the bending moment at each portion of the spiral spring can be controlled.

With the spiral spring according to the present invention, variations in stress distribution can be reduced in the maximally deformed state, in which the stress becomes maximum, compared to a spiral spring of a non-contact type (a spiral spring in which portions of a spring material that are adjacent in the radial direction do not contact each other in the maximally deformed state) with a free outer end (with an outer end portion of the spiral spring retained on an outer fixing member in a swingable (moment-free) manner) described in Patent Documents 1 and 2. In addition, the maximum value of the stress can be reduced. Thus, the set value of the strength of the spiral spring can be reduced. Hence, the weight and the size of the spiral spring according to the present invention can be reduced easily.

In addition, in the maximally deformed state, the spiral spring according to the present invention includes the non-contact section. Therefore, advantages of a spiral spring of a non-contact type, such as a high torque transfer efficiency, can be obtained. Moreover, in the maximally deformed state, the spiral spring according to the present invention includes the contact section. Therefore, advantages of a spiral spring of a contact type (a spiral spring in which at least some portions of a spring material that are adjacent in the radial direction contact each other in the maximally deformed state), such as a small stress and that it can be downsized easily, can be obtained. Thus, with the spiral spring according to the present embodiment, both advantages of a spiral spring of a non-contact type and advantages of a spiral spring of a contact type can be obtained.

(2) In the configuration according to the above (1), preferably, the inner reference portion is an inner contact portion disposed at a boundary between the inner end portion and the spiral portion, or one of contact points between the inner fixing member and the spiral portion that is the closest to the inner end portion.

With the present configuration, the inner contact portion is disposed at (α) the boundary between the inner end portion and the spiral portion, or (β) one of contact points between the inner fixing member and the spiral portion that is the closest to the inner end portion. For (β), in the case where there is a single contact point between the inner fixing member and the spiral portion, the inner contact portion is disposed at the contact point. For (β), in the case where there are a plurality of contact points between the inner fixing member and the spiral portion, meanwhile, the inner contact portion is disposed at one of the contact points that is the closest to the inner end portion. With the present configuration, the inner contact portion can be disposed at a desired position by adjusting the positions of the inner end portion and the inner fixing member.

(2-1) In the configuration according to the above (2), preferably, the inner end portion has a straight portion and a curved portion with a constant curvature that is continuous with the spiral portion, and the inner contact portion is disposed at the boundary between the curved portion and the spiral portion. With the present configuration, the inner contact portion can be disposed utilizing the boundary between the curved portion and the spiral portion.

(3) In the configuration according to the above (1), preferably, the inner reference portion is disposed at a contact point between a contact guide member, which is disposed independently of the inner fixing member, and the spiral portion. In the present configuration, the inner reference portion is independent of the inner fixing member. Therefore, the positions of the inner end portion and the inner fixing member can be set with a higher degree of freedom. In addition, the position of the inner reference portion can be set with a higher degree of freedom.

(4) In the configuration according to any one of the above (1) to (3), preferably, a total number of turns in a natural state, in which no load is applied, is two turns or more and five turns or less; and when a distance from the spiral center of the spiral portion to a minimum diameter portion in the natural state is defined as an inside diameter R1, a distance from the spiral center of the spiral portion to a maximum diameter portion in the natural state is defined as an outside diameter R2, and a turn interval λ between portions of the spring material that are adjacent in the radial direction of the spiral portion in the natural state is defined as λ=(R2−R1)/R2, the turn interval λ is 0.45 or more and 0.65 or less.

With the present configuration, the spiral spring according to the present invention can be used in place of a general-purpose spiral spring. The range of the total number of turns (two turns or more and five turns or less) is determined on the basis of the installation space for the spiral spring, the spring characteristics, the stress, and so forth. In addition, the range of the turn interval λ (0.45 or more and 0.65 or less) is determined on the basis of the inside diameter of the spiral spring, the size of the spring material, the method of manufacturing the spiral spring, and so forth.

### Effects of the Invention

According to the present invention, it is possible to provide a spiral spring capable of reducing the maximum value of a stress and capable of reducing variations in stress distribution.

### BRIEF DESCRIPTION OF THE DRAWINGS

FIG. 1 is a schematic side view of a vehicle seat, in which a spiral spring according to a first embodiment is disposed, in a forwardly inclined state.

FIG. 2 is an enlarged view of a portion inside a circle II of FIG. 1.

FIG. 3 is a schematic side view of the vehicle seat, in which the spiral spring is disposed, in a rearwardly inclined state.

FIG. 4 is an enlarged view of a portion inside a circle IV of FIG. 3.

FIG. 5 is an enlarged view of a portion inside a circle V of FIG. 4.

FIG. 6 is an enlarged view of a portion inside a circle VI of FIG. 4.

FIG. 7A is a schematic view (No. 1) that illustrates a method of setting a spiral center of a spiral portion in the maximally deformed state, FIG. 7B is a schematic view (No. 2) that illustrates the setting method, and FIG. 7C is a schematic view (No. 3) that illustrates the setting method.

FIG. 8 is a side view of a spiral spring according to a second embodiment in a rearwardly inclined state.

FIG. 9 is a graph that illustrates the relationship between the position of an inner contact portion in Example 1 in the maximally deformed state and the stress increase rate.

FIG. 10 is a graph that illustrates the relationship between the turn position in Example 1 in the maximally deformed state and the stress,

### DESCRIPTION OF THE REFERENCE NUMERALS

1 SPIRAL SPRING
3 INNER FIXING MEMBER
4 OUTER FIXING MEMBER
8 VEHICLE SEAT
20 INNER END PORTION
21 SPIRAL PORTION
22 OUTER END PORTION
23 CONTACT GUIDE MEMBER
80 SEAT CUSHION
81 SEAT BACK
200 STRAIGHT PORTION
201 CURVED PORTION
220 STRAIGHT PORTION
221 CURVED PORTION
800 CUSHION FRAME
810 BACK FRAME
810a BRACKET
A INNER CONTACT PORTION
B OUTER CONTACT PORTION
C CONTACT SECTION
D INNER REFERENCE PORTION
h1 to h3 SECTION
i1 to i3 APPROXIMATE CIRCLE
θ1 to θ3 CENTRAL ANGLE
L REFERENCE LINE
O SPIRAL CENTER
R1 INSIDE DIAMETER
R2 OUTSIDE DIAMETER
S SPRING MATERIAL
a CENTER OF CURVATURE
b CENTER OF CURVATURE

### MODES FOR CARRYING OUT THE INVENTION

Embodiments in which a spiral spring according to the present invention is embodied as a spiral spring configured to swing a seat back will be described below.

### First Embodiment

### Arrangement and Configuration of Spiral Spring

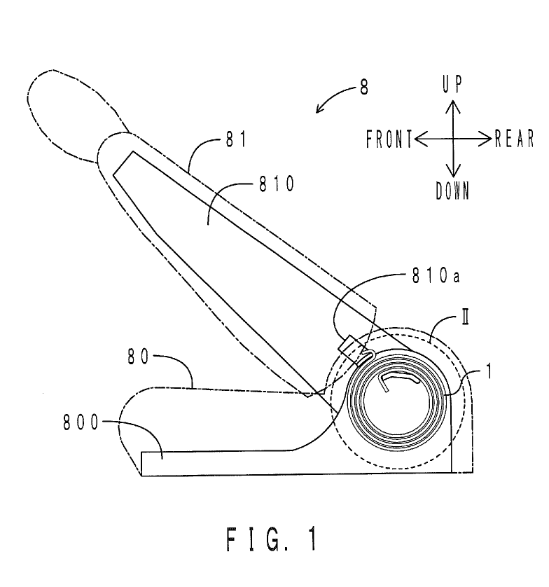

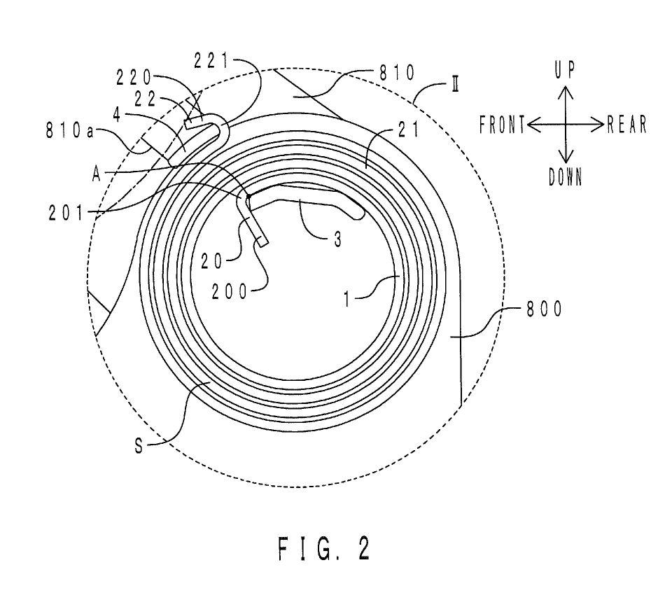

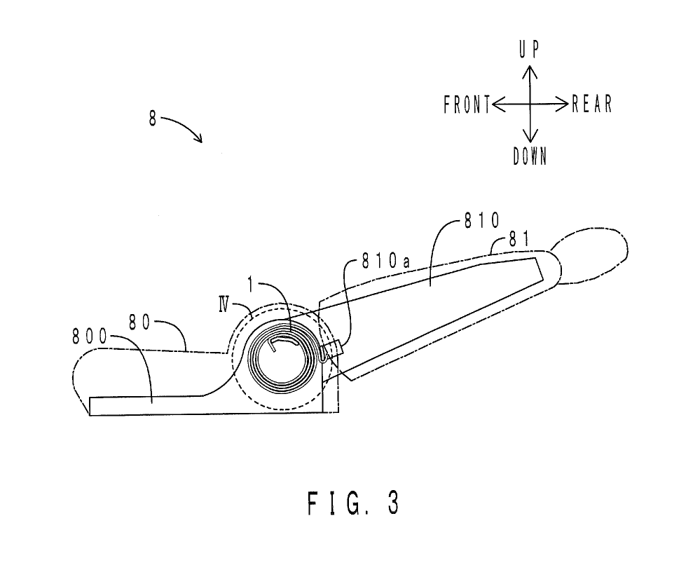

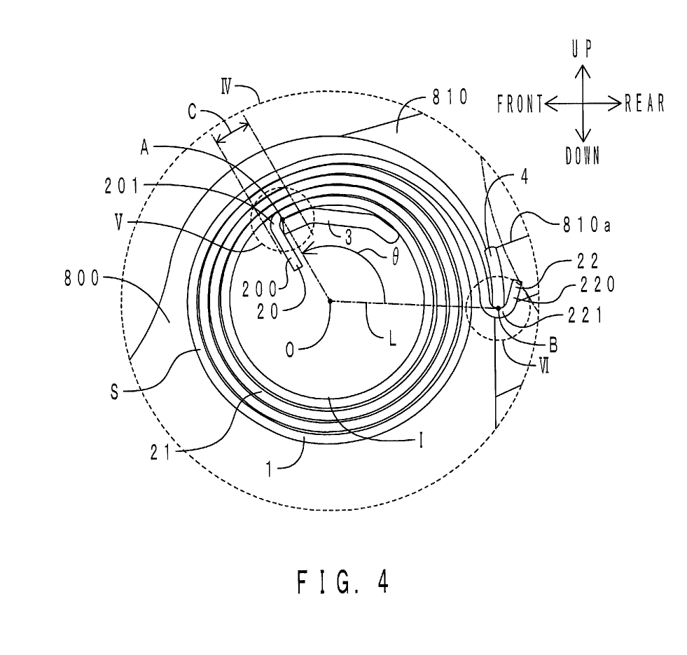

First, the arrangement and the configuration of a spiral spring according to the present embodiment will be described. FIG. 1 is a schematic side view of a vehicle seat, in which a spiral spring according to the present embodiment is disposed, in a forwardly inclined state. FIG. 2 is an enlarged view of a portion inside a circle II of FIG. 1. FIG. 3 is a schematic side view of the vehicle seat, in which the spiral spring is disposed, in a rearwardly inclined state. FIG. 4 is an enlarged view of a portion inside a circle IV of FIG. 3.

As illustrated in FIGS. 1 and 3, a vehicle seat 8 includes a seat cushion 80 (indicated by a dash-and-dot line for convenience of description) and a seat back 81 (indicated by a dash-and-dot line for convenience of description). The seat cushion 80 includes cushion frames 800 made of steel and having a plate shape. A pair of cushion frames 800 are disposed on the left and the right. The cushion frames 800 are fixed to a vehicle floor (not illustrated) via a seat slide mechanism (not illustrated).

The seat back 81 includes back frames 810 made of steel. A pair of back frames 810 are disposed on the left and the right. The pair of back frames 810 are coupled to each other by a coupling rod (not illustrated) made of steel. The lower end of the back frames 810 and the rear end of the cushion frames 800 are swingably coupled to each other by a shaft (not illustrated).

The seat back 81 is swingable in the front-rear direction with respect to the seat cushion 80 from the forwardly inclined state of FIG. 1 to the rearwardly inclined state of FIG. 3. The forwardly inclined state of FIG. 1 is included in the concept of the “minimally deformed state” according to the present invention. The rearwardly inclined state of FIG. 3 is included in the concept of the “maximally deformed state” according to the present invention.

As illustrated in FIGS. 2 and 4, an inner fixing member 3 is disposed in the cushion frames 800. Meanwhile, an outer fixing member 4 is disposed at a bracket 810a of the back frames 810.

A spiral spring 1 includes an inner end portion 20, a spiral portion 21, and an outer end portion 22. The spiral spring 1 is formed of a belt-like spring material S. In the natural state (no-load state), the spiral portion 21 has an Archimedean spiral shape. That is, in the natural state, the turn interval (interval between portions of the spring material S that are adjacent in the radial direction) is constant.

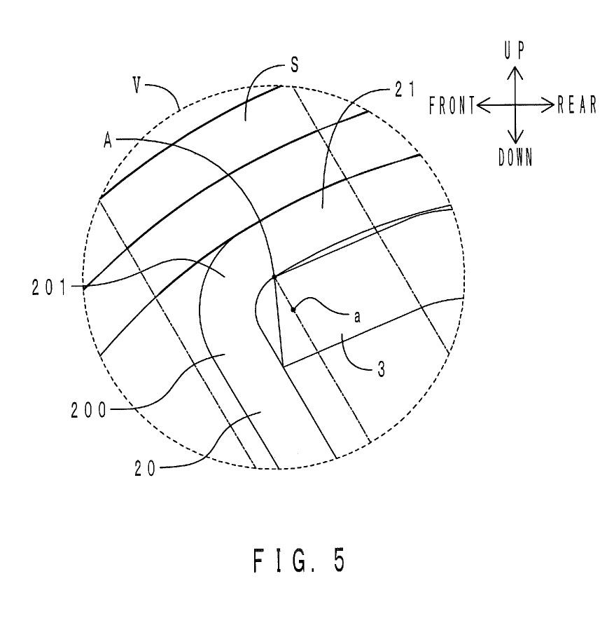

The inner end portion 20 is fixed to the inner fixing member 3. The inner end portion 20 is not freely swingable with respect to the inner fixing member 3. FIG. 5 is an enlarged view of a portion inside a circle V of FIG. 4. As illustrated in FIG. 5, the inner end portion 20 includes a straight portion 200 and a curved portion 201. The straight portion 200 is disposed on the radially inner side of the spiral portion 21. The curved portion 201 couples the straight portion 200 and the spiral portion 21 to each other. The curvature of the curved portion 201 is constant. The center of curvature a of the curved portion 201 is located on the radially inner side of the spiral portion 21. An inner contact portion A is disposed at the boundary between the curved portion 201 and the spiral portion 21. In addition, the spring material S contacts the inner fixing member 3 at the inner contact portion A.

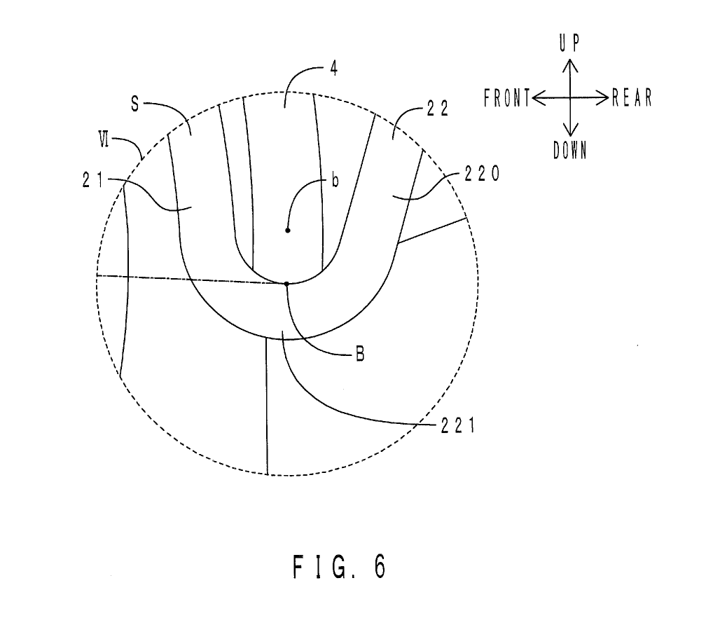

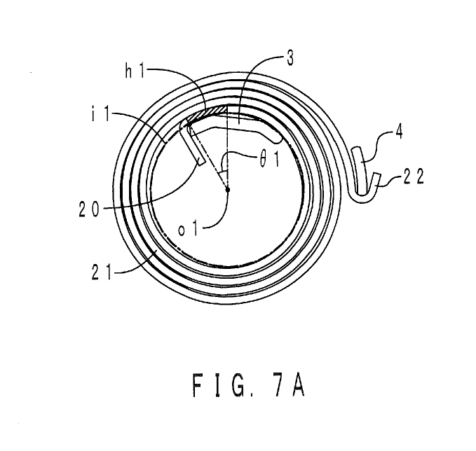

As illustrated in FIG. 4, the outer end portion 22 is retained on the outer fixing member 4. The outer end portion 22 is freely swingable with respect to the outer fixing member 4. FIG. 6 is an enlarged view of a portion inside a circle VI of FIG. 4. As illustrated in FIG. 6, the outer end portion 22 includes a straight portion 220 and a curved portion 221. The straight portion 220 is disposed on the radially outer side of the spiral portion 21. The curved portion 221 couples the straight portion 220 and the spiral portion 21 to each other. The curvature of the curved portion 221 is constant. The center of curvature b of the curved portion 221 is located on the radially outer side of the spiral portion 21. An outer contact portion B is disposed at an end, in the circumferential direction, of the contact interface between the outer fixing member 4 and the curved portion 221.

In the forwardly inclined state, as illustrated in FIG. 2, all portions of the spring material S that are adjacent in the radial direction are spaced from each other. In the rearwardly inclined state, in contrast to the forwardly inclined state, the spiral portion 21 is wound up. Therefore, in the rearwardly inclined state, as illustrated in FIG. 4, a contact section C appears. The contact section C appears on the radially outer side of the inner contact portion. In the contact section C, all portions of the spring material S that are adjacent in the radial direction contact each other. In a section other than the contact section C, of the entire circumference of the spiral spring 1, portions of the spring material S that are adjacent in the radial direction do not contact each other. The section other than the contact section C corresponds to the “non-contact section” according to the present invention.

The contact section C is created by the inner contact portion A. In addition, the position of the contact section C is adjusted by the inner contact portion A. The inner contact portion A is disposed at a position θ corresponding to a central angle of 120° about a spiral center O of the spiral portion 21 along the direction of extension of the spiral portion 21 (counterclockwise direction in FIG. 4) with reference to a reference line L. The reference line L connects between the spiral center O and the outer contact portion B in the rearwardly inclined state.

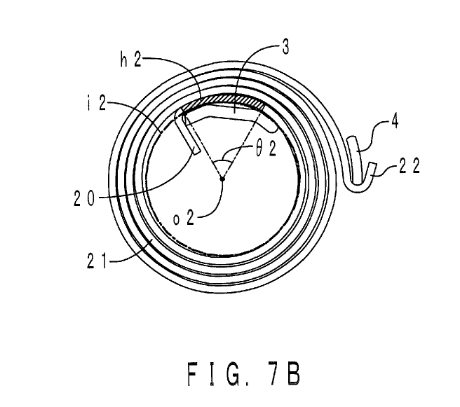

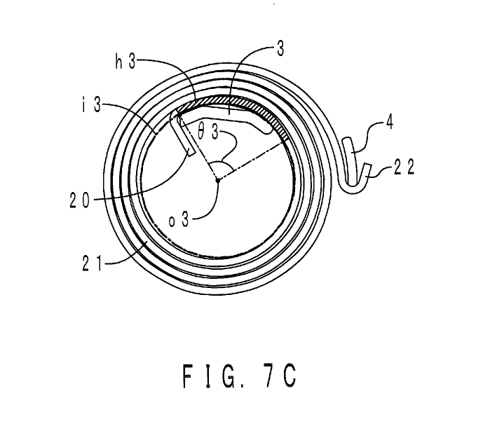

FIGS. 7A to 7C are each a schematic view that illustrates a method of setting the spiral center of the spiral portion in the maximally deformed state. First, as illustrated in FIG. 7A, an approximate circle i1 for a predetermined section h1 that starts at a turn position of 0 is prepared, and the center of and the central angle θ1 of the approximate circle i1 are calculated. Next, as illustrated in FIG. 7B, an approximate circle i2 for a predetermined section h2 (>h1) that starts at a turn position of 0 is prepared, and the center o2 and the central angle θ2 of the approximate circle i2 are calculated. In this way, the center and the central angle are calculated while gradually expanding the predetermined section. As illustrated in FIG. 7C, an approximate circle i3 for a predetermined section h3 (>h2) that starts at a turn position of 0 is prepared, and the center o3 and the central angle θ3 of the approximate circle i3 are calculated. If the thus calculated central angle θ3 is 90° (that is, at a turn position of 0.25), the center o3 is set as the spiral center O (see FIG. 4) of the spiral portion in the maximally deformed state.

[Function and Effect]

Next, the function and the effect of the spiral spring according to the present embodiment will be described. In the rearwardly inclined state (maximally deformed state), as illustrated in FIG. 4, the spiral spring 1 includes the contact section C, in which all portions of the spring material S that are adjacent in the radial direction contact each other, and the non-contact section (a section other than the contact section C, of the entire circumference of the spiral spring 1), in which at least some portions of the spring material S that are adjacent in the radial direction do not contact each other). That is, in the rearwardly inclined state, at least one non-contact section and at least one contact section C are disposed in the circumferential direction of the spiral spring 1. In the contact section C, all portions of the spring material S that are adjacent in the radial direction contact each other. In the non-contact section, in contrast, at least some portions of the spring material S that are adjacent in the radial direction do not contact each other.

In the spiral spring 1 according to the present embodiment, the contact section C is intentionally created by setting the inner contact portion A. Moreover, the position of the contact section C is adjusted by setting the position of the inner contact portion A to the position θ at a central angle of 120° (within a section corresponding to a central angle of 80° or more and 160° or less). By adjusting the position of the contact section C, the bending moment at each portion of the spiral spring 1 can be controlled. Therefore, it is possible to reduce variations in stress distribution in the rearwardly inclined state, in which the stress becomes maximum, compared to a spiral spring of a non-contact type with a free outer end. In addition, the maximum value of the stress can be reduced. Thus, the weight and the size of the spiral spring 1 can be reduced easily.

In addition, the spiral spring 1 according to the present embodiment includes the non-contact section in the rearwardly inclined state. Therefore, advantages of a spiral spring of a non-contact type, such as a high torque transfer efficiency, can be obtained. Moreover, the spiral spring 1 according to the present embodiment includes the contact section C in the rearwardly inclined state. Therefore, advantages of a spiral spring of a contact type, such as a small stress and that it can be downsized easily, can be obtained. Thus, with the spiral spring 1 according to the present embodiment, both advantages of a spiral spring of a non-contact type and advantages of a spiral spring of a contact type can be obtained.

With the spiral spring 1 according to the present embodiment, the inner contact portion A can be disposed at a desired position by adjusting the positions of the inner end portion 20 and the inner fixing member 3. In addition, as illustrated in FIG. 5, the inner contact portion A can be disposed utilizing the boundary between the curved portion 201 and the spiral portion 21.

### Second Embodiment

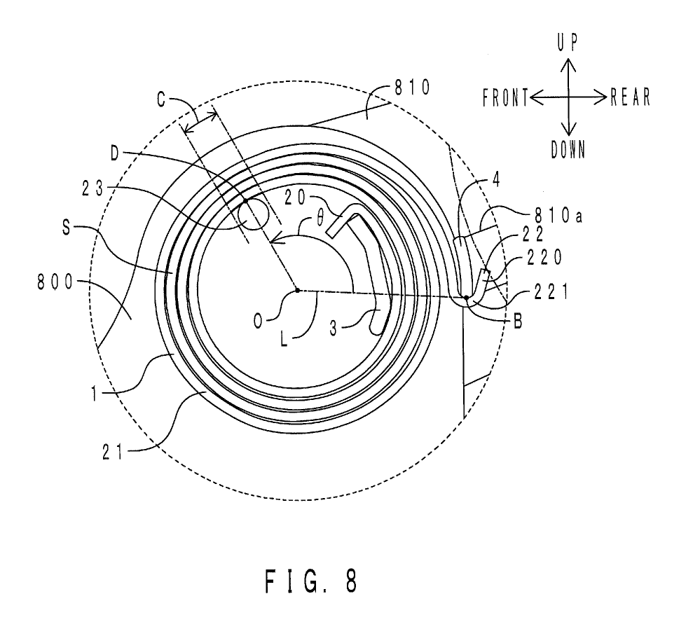

A spiral spring according to the present embodiment is different from the spiral spring according to the first embodiment in that a contact guide member is provided. Only such a difference will be described below. FIG. 8 is a side view of a spiral spring according to the present embodiment in a rearwardly inclined state. Components corresponding to those of FIG. 4 are denoted by the same reference symbols.

As illustrated in FIG. 8, a contact guide member 23 is disposed on the radially inner side of the spiral portion 21. The contact guide member 23 has a short round bar shape (pin shape). The contact guide member 23 contacts the spiral portion 21 from the radially inner side. An inner reference portion D is disposed at the contact point between the contact guide member 23 and the spiral portion 21.

The spiral spring 1 according to the present embodiment and the spiral spring according to the first embodiment have the same function and effect as far as components that are common in configuration are concerned. In the spiral spring 1 according to the present embodiment, in addition, the inner reference portion D is independent of the inner fixing member 3. Therefore, the positions of the inner end portion 20 and the inner fixing member 3 can be set with a higher degree of freedom. In addition, the position of the inner reference portion D, that is, the contact guide member 23, can be set with a higher degree of freedom.

### Other Embodiments

The spiral springs according to the embodiments of the present invention have been described above. However, the present invention is not specifically limited to the embodiments described above. Various modifications and improvements may also be made by those skilled in the art.

The numbers of contact sections C and non-contact sections provided are not specifically limited. In the contact section C, portions of the spring material S that contact each other in the radial direction may not be arranged as straight lines in the radial direction as illustrated in FIG. 4. For example, such portions of the spring material S may be arranged as curved lines (in an S shape, a C shape, or the like) or polygonal lines (in a Z shape, a zigzag shape, or the like). For example, it is only necessary that all contact interfaces (contact interfaces between portions of the spring material S that contact each other in the radial direction) should overlap each other as seen from the radially outer side or the radially inner side in the contact section C.

The state of contact between portions of the spring material S that contact each other in the radial direction in the contact section C is not specifically limited. The state of contact may be any of surface contact, line contact, and point contact. In addition, such states of contact may be combined as appropriate.

In the embodiments described above, portions of the spring material S that are adjacent in the radial direction do not contact each other at all in the non-contact section. However, such portions of the spring material S may partially contact each other in the non-contact section.

The shape of the spiral portion 21 in the natural state is not specifically limited. For example, the spiral portion 21 may have a Fermat's spiral shape, a Lituus spiral shape, a clothoid curve shape, a hyperbolic spiral shape, or a logarithmic spiral shape. The material of the spring material S is not specifically limited. For example, the material type of the spring material S may be a hard steel wire, a carbon steel wire such as a piano wire, a carbon steel strip, a stainless steel wire, or a stainless steel strip. The shape of the spring material S is not specifically limited. The shape of the spring material S may be a plate shape or a wire shape. The sectional shape of the spring material S in the lateral direction is not specifically limited. The sectional shape of the spring material S may be a perfect circle shape, an elliptical shape, a rectangular shape, a trapezoidal shape, an I shape, an L shape, or a T shape. In addition, the spring material S may be solid or hollow.

The shape of the inner end portion 20 and the inner fixing member 3 is not specifically limited. It is only necessary that the inner end portion 20 should be fixed to the inner fixing member 3 so as not to be swingable. The shape of the outer end portion 22 and the outer fixing member 4 is not specifically limited. It is only necessary that the outer end portion 22 should be fixed to the outer fixing member 4 so as to be swingable. The sectional shape of the contact guide member 23 as seen from the left side or the right side is not specifically limited. The sectional shape of the contact guide member 23 may be a an arcuate shape, a perfect circle shape, an elliptical shape, or a polygonal shape such as a triangular shape, a quadrangular shape, a hexagonal shape, and an octagonal shape.

The inner contact portion A may be disposed at the contact point between the inner fixing member 3 and the spiral portion 21. In the case where there are a plurality of contact points between the inner fixing member 3 and the spiral portion 21 as illustrated in FIG. 4, the inner contact portion may be disposed at one of the contact points that is the closest to the inner end portion 20. Thus, the inner contact portion A may not be disposed at the boundary between the curved portion 201 and the spiral portion 21. The usage of the spiral spring 1 is not specifically limited. For example, the spiral spring 1 may be used in a tumbling mechanism of a vehicle seat, a seat belt winding mechanism, or the like.

### EXAMPLES

The results of an FEM (finite element method) analysis performed on a spiral spring (Example 1) that is the same in shape as the spiral spring 1 according to the first embodiment illustrated in FIG. 4 will be described below.

<Analysis Conditions>

Commercially available software was used in the analysis. In the analysis, contact between the spring material S and the fixing members (the inner fixing member 3 and the outer fixing member 4) and contact between portions of the spring material S were also taken into consideration.

<Position θ of Inner Contact Portion A>

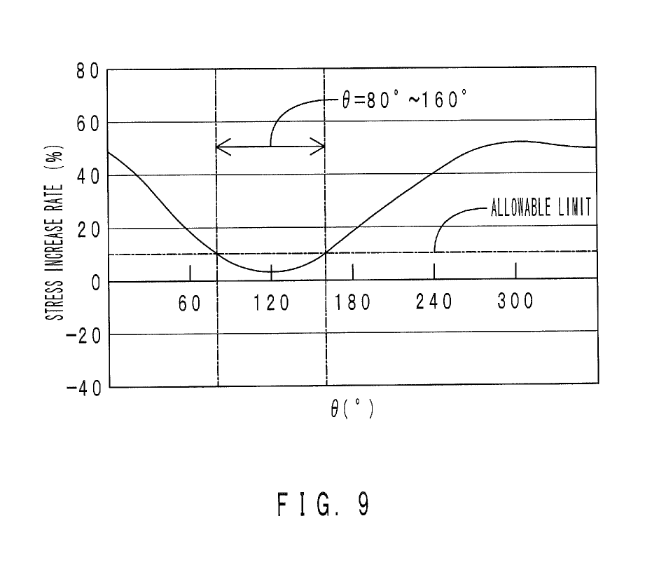

FIG. 9 illustrates the relationship between the position of the inner contact portion in Example 1 in the maximally deformed state and the stress increase rate. The stress increase rate means the maximum value of the stress of the spiral spring 1 with the design value of the stress defined as 100%. When torque is defined as M, the width (belt width) of the spring material S in the lateral direction is defined as b, and the plate thickness of the spring material S is defined as h, the design value σ is calculated by the following formula (I):

σ=(6×M)/(b×h²) Formula (I)

A stress of the spiral spring 1 up to 10% increased (allowable limit in FIG. 9) from the design value σ is allowed. As illustrated in FIG. 9, by setting the position θ (see FIG. 4) of the inner contact portion A to be 80° or more and 160° or less, the maximum value of the stress of the spiral spring 1 can be made equal to or less than the allowable limit. That is, the maximum value of the stress can be reduced. In the case where the position θ is less than 80° and in the case where the position θ is more than 160°, on the other hand, the maximum value of the stress cannot be reduced.

### <Stress Distribution>

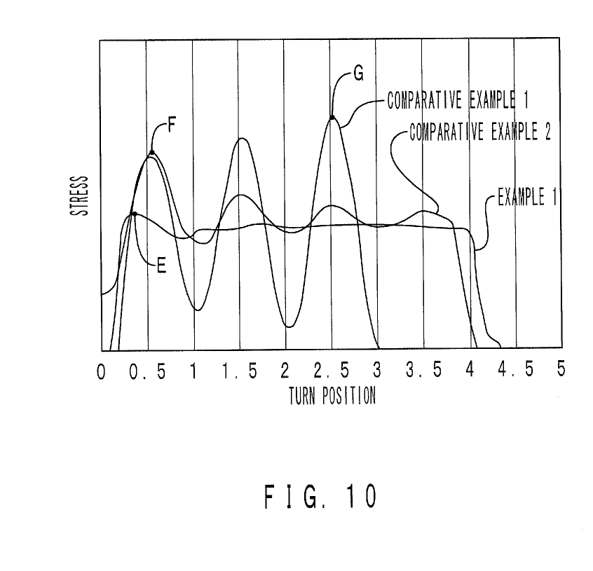

FIG. 10 illustrates the relationship between the turn position in Example 1 in the maximally deformed state and the stress. Data for a spiral spring of a non-contact type with a free outer end are indicated as Comparative Example 1. In addition, data for a case where the position θ of the inner contact portion A is at 30° in Example 1 are indicated as Comparative Example 2.

The turn position means a position in the circumferential direction with an end portion of the spiral portion 21 on the inner end portion 20 side defined as 0. If the turn position is increased by 1, the angle is increased by 360° (one rotation) toward the outer end portion 22. For example, a turn position of 0 corresponds to a position at 0°, a turn position of 0.5 corresponds to a position at 180°, a turn position of 1 corresponds to a position at 360°, a turn position of 4.5 corresponds to a position at 1620°, and a turn position of 5 corresponds to a position at 1800°.

For Comparative Example 1, as illustrated in FIG. 10, the stress is small at turn positions of 0, 1, 2, and 3. On the other hand, the stress is large at turn positions of 0.5, 1.5, and 2.5. Thus, for Comparative Example 1, variations in stress distribution are large. In addition, the maximum value G of the stress (stress around a turn position of 2.5) is large.

For Comparative Example 2, the stress is small at turn positions of 0, 1, 2, 3, and 4. On the other hand, the stress is large at turn positions of 0.5, 1.5, 2.5, and 3.5. Thus, for Comparative Example 2, variations in stress distribution are large, although not so large as those in Comparative Example 1. In addition, the maximum value F of the stress (stress around a turn position of 0.5) is large, although not so large as that in Comparative Example 1.

For Example 1 (with the position θ of the inner contact portion A at) 100°, in contrast, the stress is generally constant irrespective of the turn position. That is, for Example 1, variations in stress distribution can be reduced.

In addition, with the maximum value G of the stress in Comparative Example 1 defined as 100%, the maximum value E of the stress in Example 1 (stress around a turn position of 0.5) is about 60%. In addition, with the maximum value F of the stress in Comparative Example 2 defined as 100%, the maximum value E of the stress in Example 1 is about 75%. Thus, for Example 1, the maximum value of the stress can be reduced.

1. A spiral spring made of a belt-like spring material and including an inner end portion that is fixed to an inner fixing member, an outer end portion that is swingably retained on an outer fixing member, and a spiral portion that extends spirally to couple the inner end portion and the outer end portion to each other, the spiral spring being elastically deformable from a minimally deformed state to a maximally deformed state by rotating the inner end portion and the outer end portion relative to each other, the spiral spring being wherein:
in the maximally deformed state, the spiral spring includes a non-contact section, in which at least some portions of the spring material that are adjacent in a radial direction do not contact each other, and a contact section, in which all portions of the spring material that are adjacent in the radial direction contact each other;
an inner reference portion is disposed in a section corresponding to a central angle of 80° or more and 160° or less about a spiral center of the spiral portion along a direction of extension of the spiral portion with reference to a reference line that connects between the spiral center and an outer contact portion, at which the outer end portion and the outer fixing member contact each other, in the maximally deformed state, the inner reference portion being disposed on a radially inner side of the spiral portion; and
the contact section is disposed on a radially outer side of the inner reference portion.

2. The spiral spring according to claim 1, wherein
the inner reference portion is an inner contact portion disposed at a boundary between the inner end portion and the spiral portion, or one of contact points between the inner fixing member and the spiral portion that is the closest to the inner end portion.

3. The spiral spring according to claim 1, wherein
the inner reference portion is disposed at a contact point between a contact guide member, which is disposed independently of the inner fixing member, and the spiral portion.

4. The spiral spring according to claim 1, wherein:
a total number of turns in a natural state, in which no load is applied, is two turns or more and five turns or less; and
when a distance from the spiral center of the spiral portion to a minimum diameter portion in the natural state is defined as an inside diameter R1, a distance from the spiral center of the spiral portion to a maximum diameter portion in the natural state is defined as an outside diameter R2, and a turn interval 2 between portions of the spring material that are adjacent in the radial direction of the spiral portion in the natural state is defined as λ=(R2−R1)/R2,
the turn interval λ is 0.45 or more and 0.65 or less.

5. The spiral spring according to claim 2, wherein:
a total number of turns in a natural state, in which no load is applied, is two turns or more and five turns or less; and
when a distance from the spiral center of the spiral portion to a minimum diameter portion in the natural state is defined as an inside diameter R1, a distance from the spiral center of the spiral portion to a maximum diameter portion in the natural state is defined as an outside diameter R2, and a turn interval λ between portions of the spring material that are adjacent in the radial direction of the spiral portion in the natural state is defined as =(R2−R1)/R2,
the turn interval λ is 0.45 or more and 0.65 or less.

6. The spiral spring according to claim 3, wherein:
a total number of turns in a natural state, in which no load is applied, is two turns or more and five turns or less; and
when a distance from the spiral center of the spiral portion to a minimum diameter portion in the natural state is defined as an inside diameter R1, a distance from the spiral center of the spiral portion to a maximum diameter portion in the natural state is defined as an outside diameter R2, and a turn interval λ between portions of the spring material that are adjacent in the radial direction of the spiral portion in the natural state is defined as λ=(R2−R1)/R2,
the turn interval λ is 0.45 or more and 0.65 or less.
